(19) United States
(12) Patent Application Publication
(10) Pub. No.: US 2015/0190295 A1
(43) Pub. Date: Jul. 9, 2015

(54) BED WITH OVERTURN FUNCTION

(71) Applicant: National Tsing Hua University, Hsinchu City (TW)

(72) Inventors: Pei-Lum TSO, Taipei City (TW); I-Chu KUO, Keelung City (TW)

(21) Appl. No.: 14/487,852

(22) Filed: Sep. 16, 2014

(30) Foreign Application Priority Data
Jan. 8, 2014 (TW) 103103119

(51) Int. Cl. A61G 7/057; A61G 7/018; A61G 7/008

(52) U.S. Cl. CPC A61G 7/0573; A61G 7/008; A61G 7/018

(57) ABSTRACT

A bed with overturn function includes a pulley set, a driving lever and a four-bar linkage structure. The pulley set has a first pulley and a second pulley. The first pulley is connected to the second pulley through a belt, and the second pulley rotates according to the first pulley. The driving lever passes through the first pulley. when the driving lever rotates in a first direction, the first pulley rotates in the first direction. The four-bar linkage structure has an input link connected to the driving lever through the pulley set, and rotates according to the driving lever. When the input link rotates to a first angle, the four-bar linkage structure rises from a first position to a second position.

### BACKGROUND OF THE INVENTION

1. Field of the Invention

The invention relates to a bed with overturn function, and more particularly to a bed with overturn function using a four-bar linkage structure.

2. Related Art

The pressure sores are formed due to the long-time contact of the patient's body with the bed surface. If the patient does not move for a long time, pressure sores tend to be generated on specific surfaces of the body. So, it is better that the moving frequency is higher, but a lot of manpower has to be spent, and the caretaker's loading is increased.

In order to change the contact of the bed surface with the patient's body and in the condition of considering the patient who cannot move freely, the deformation of the bed surface can be utilized to achieve the object to prevent the formation of the pressure sores and decrease the loading of the healthcare manpower.

### SUMMARY OF THE INVENTION

An object of the invention is to provide a bed with overturn function, wherein a horizontal included angle of the bed surface can be changed.

Another object of the invention is to provide a bed with overturn function, to change the patient's position in the condition when the direction of gravity is unchanged.

Still another object of the invention is to provide a bed with overturn function to decrease the opportunity of the formation of the pressure sores.

The invention provides a bed with overturn function. The bed includes a pulley set, a driving lever and a four-bar linkage structure. The pulley set has a first pulley and a second pulley. The first pulley is connected to the second pulley through a belt, and the second pulley rotates according to the first pulley. The driving lever passes through the first pulley. When the driving lever rotates in a first direction, the first pulley rotates in the first direction. The four-bar linkage structure has an input link connected to the driving lever through the pulley set. The four-bar linkage structure rotates according to the driving lever. When the input link rotates to a first angle, the four-bar linkage structure rises from a first position to a second position.

### BRIEF DESCRIPTION OF THE DRAWINGS

FIG. 1 is a schematic view showing a bed with overturn function according to an embodiment of the invention.

FIG. 2 is a bottom view showing a bed with overturn function according to an embodiment of the invention.

FIG. 3 is a side view showing a bed with overturn function according to an embodiment of the invention.

FIG. 4A is a schematic view showing a four-bar linkage structure according to an embodiment of the invention.

FIG. 4B is a schematic view showing an operation of the four-bar linkage structure according to an embodiment of the invention.

### DETAILED DESCRIPTION OF THE INVENTION

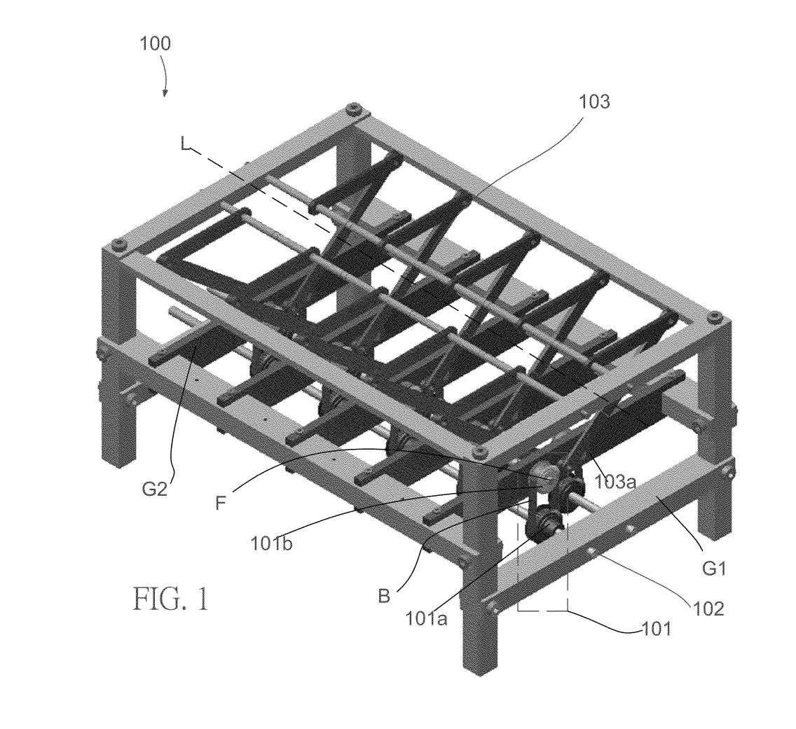

FIG. 1 is a schematic view showing a bed 100 with overturn function according to an embodiment of the invention. Referring to FIG. 1, the bed 100 with overturn function includes a pulley set 101, a driving lever 102 and a four-bar linkage structure 103.

Please note that the bed 100 in this embodiment has a plurality of pulley sets 101, a plurality of driving levers 102, and a plurality of four-bar linkage structures 103. However, the invention should not be restricted to the numbers of the pulley sets 101, driving levers 102, and four-bar linkage structures 103.

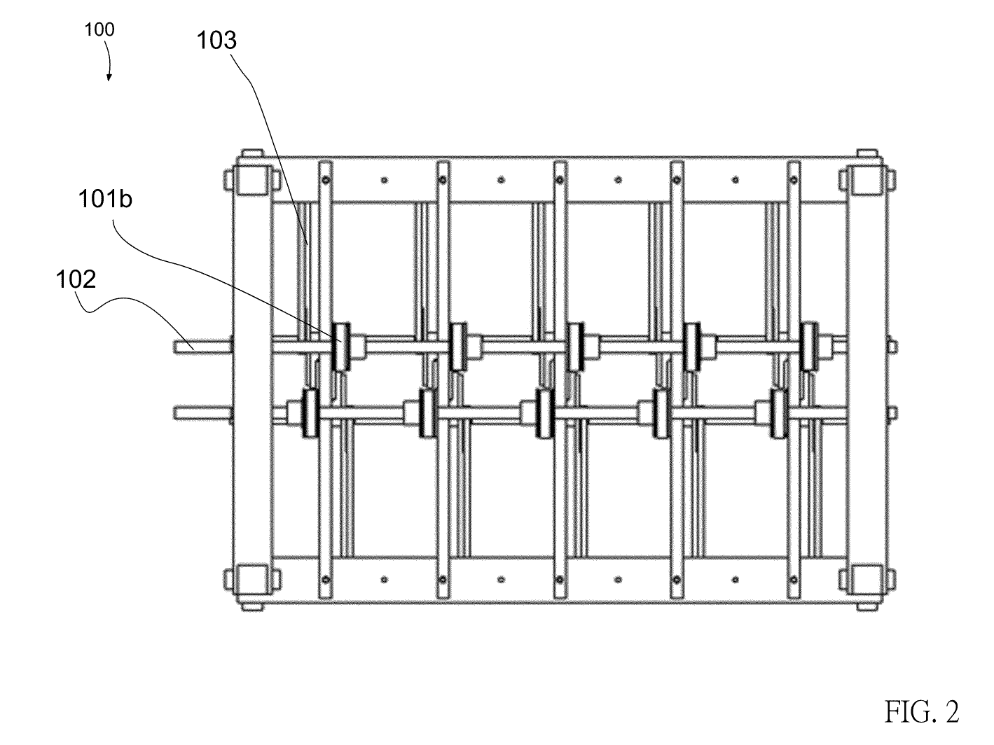

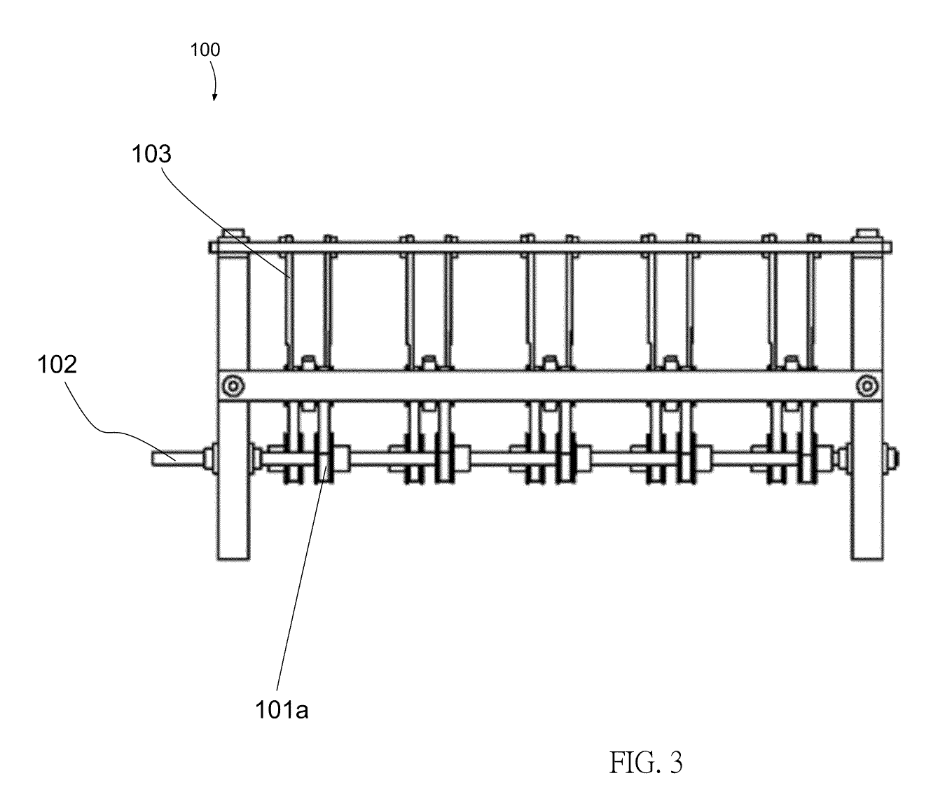

FIG. 2 is a bottom view showing a bed with overturn function according to an embodiment of the invention. FIG. 3 is a side view showing a bed with overturn function according to an embodiment of the invention. Please refer to FIGS. 2 and 3. In this embodiment, each pulley set 101 has a first pulley 101a and a second pulley 101b. The first pulley 101a is connected to the second pulley 101b through a belt B.

When the first pulley 101a rotates, the first pulley 101a can rotate the second pulley 101b through the belt B. In other words, the second pulley 101b rotates according to the first pulley 101a. In addition, the second pulley 101b and the first pulley 101a in this embodiment rotate in the same direction.

In this embodiment, the first pulley 101a and the second pulley 101b are hollow structures, and the first pulley 101a and the second pulley 101b have chambers (not shown).

Also, the driving lever 102 passes through the first pulley 101a. When the driving lever 102 rotates in a direction, the first pulley 101a rotates in the same direction, and the first pulley 101a rotates the second pulley 101b in the same direction.

Please note that the bed 100 of the invention has two driving levers 102 disposed on two sides of a center shaft L, respectively. The driving lever 102 extends from a first lateral side G1 of the bed 100 to a second lateral side G2 of the bed 100 along a spindle L. So, in this invention, each driving lever 102 can control the up and down of one half side of the bed 100.

In this embodiment, the driving levers 102 pass through the first pulleys 101a of five pulley sets 101, and the driving levers 102 pass through the inner chamber of each first pulley 101a.

In addition, each four-bar linkage structure 103 has an input link 103a connected to the driving lever 102 through the pulley set 101, and the four-bar linkage structure 103 rotates according to the driving lever 102. In other words, each four-bar linkage structure 103 works in conjunction with one pulley set 101. When the driving lever 102 rotates, all pulley sets 101 and the four-bar linkage structures 103 operate concurrently.

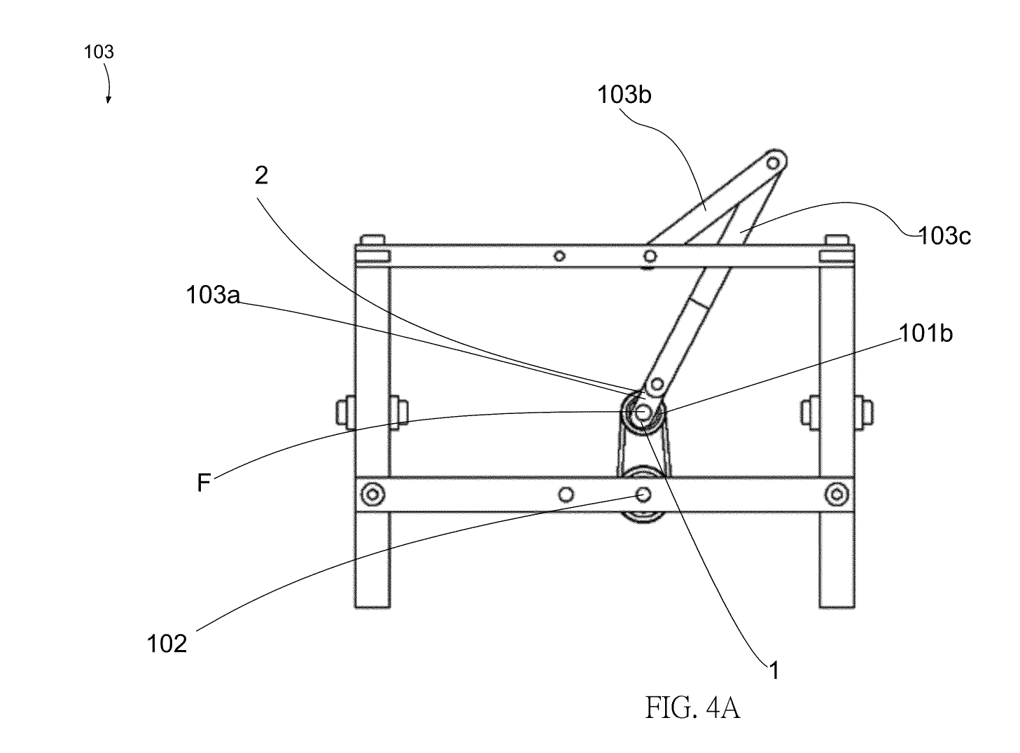

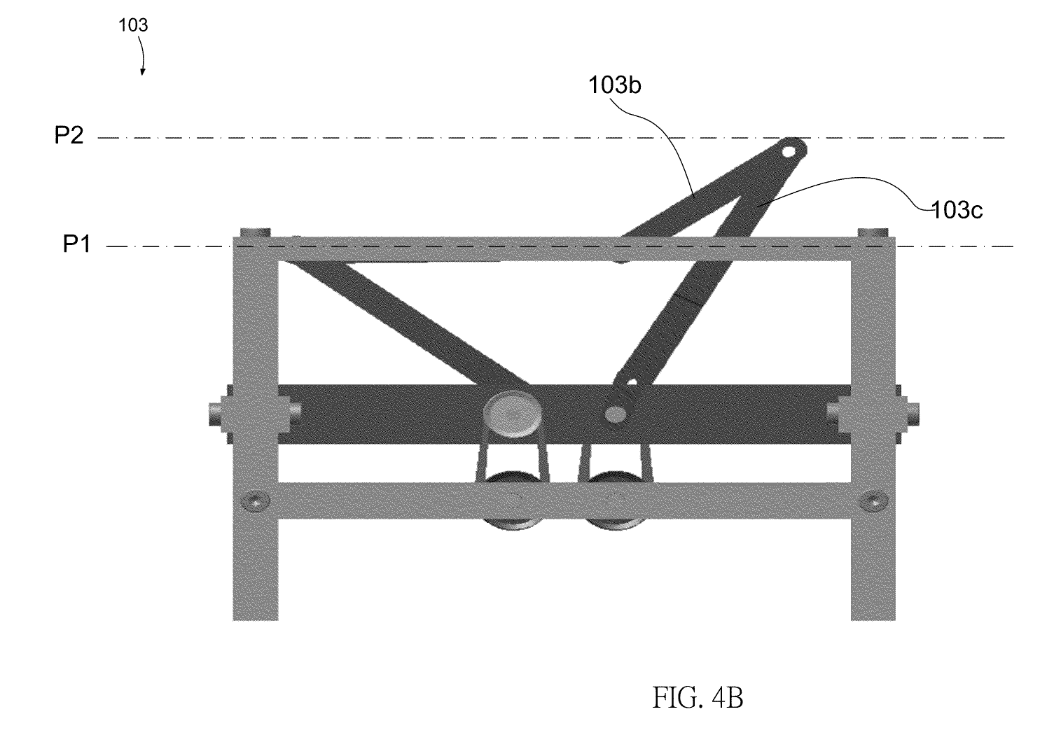

FIG. 4A is a schematic view showing a four-bar linkage structure according to an embodiment of the invention. Referring to FIG. 4A, the bed 100 further includes a fixing lever F. In this embodiment, the bed 100 has a plurality of fixing levers F, and each fixing lever F passes through the inner chamber of the corresponding second pulley 101b and a first end 1 of the input link 103a. So, the rotating driving lever 102 can drive the four-bar linkage structure 103 to perform the corresponding operation.

It is to be noted that the invention does not utilize the same shaft to drive the bed 100 to prevent the lever from interference. So, the transmission of the pulley set 101 is adopted so that the driving lever 102 and the input link 103a are not located on the same height or level.

In one embodiment, the four-bar linkage structure 103 is implemented by a crank-rocker.

In this invention, the four-bar linkage structure 103 further includes an overturn lever 103b and a connection lever 103c. The overturn lever 103b supports or lifts a bed surface. A second end 2 of the input link 103a is connected to the overturn lever 103b through the connection lever 103c.

FIG. 4B is a schematic view showing an operation of the four-bar linkage structure according to an embodiment of the invention. As shown in FIG. 4B, when the user rotates the driving lever 102 and the input link 103a rotates to a first angle, the four-bar linkage structure 103 may be regarded as rising from a first position P1 to a second position P2. When the input link 103a rotates to a second angle, the four-bar linkage structure 103 falls from the second position P2 to the first position P1. That is, when the input link 103a return to the initial position, the four-bar linkage structure 103 returns to the position before operation. The height of the second position P2 is greater than the height of the first position P1.

In one embodiment of the invention, when the four-bar linkage structure 103 rises to the second position P2, the included angle between the overturn lever 103b and the horizontal surface is substantially equal to 45 degrees. At this time, the user can perform the overturn operation conveniently. When the four-bar linkage structure 103 is at the first position P1, the included angle between the overturn lever 103b and the horizontal surface is substantially equal to 0 degrees, and the bed 100 returns to the state before overturn.

In this invention, when the four-bar linkage structure 103 rises to the second position P2, the included angle between the overturn lever 103b and the horizontal surface is adjusted according to a length of the connection lever 103c and a length of the input link 103a.

In another embodiment, when the four-bar linkage structure 103 rises to the second position P2, the included angle between the overturn lever 103b and the horizontal surface does not exceed 90 degrees.

In summary, the bed of the invention is a bed capable of assisting the user in turning over the body, wherein the four-bar linkage structure is utilized to change the inclination angle of the bed surface to achieve the object of overturn. In addition, because the stationary four-bar linkage structure has the good structural property, the bed still has the original function when not being used.

What is claimed is:

1. A bed with overturn function, the bed comprising:
a pulley set having a first pulley and a second pulley, wherein the first pulley is connected to the second pulley through a belt, and the second pulley rotates according to the first pulley;
a driving lever passing through the first pulley, wherein when the driving lever rotates in a first direction, the first pulley rotates in the first direction; and
a four-bar linkage structure having an input link connected to the driving lever through the pulley set, wherein the four-bar linkage structure rotates according to the driving lever;
wherein when the input link rotates to a first angle, the four-bar linkage structure rises from a first position to a second position.

2. The bed according to claim 1, wherein when the input link rotates to a second angle, the four-bar linkage structure falls from the second position down to the first position.

3. The bed according to claim 2, wherein a height of the second position is greater than a height of the first position.

4. The bed according to claim 3, further comprising:
a fixing lever passing through the second pulley and a first end of the input link.

5. The bed according to claim 4, wherein, the four-bar linkage structure further comprising:
an overturn lever for supporting or lifting a bed surface; and
a connection lever, wherein a second end of the input link is connected to the overturn lever through the connection lever.

6. The bed according to claim 5, wherein when the four-bar linkage structure rises to the second position, an included angle between the overturn lever and a horizontal surface is substantially equal to 45 degrees.

7. The bed according to claim 5, wherein when the four-bar linkage structure is at the first position, an included angle between the overturn lever and a horizontal surface is substantially equal to 0 degrees.

8. The bed according to claim 5, wherein when the four-bar linkage structure rises to the second position, an included angle between the overturn lever and a horizontal surface is adjusted according to a length of the connection lever and a length of the input link.

9. The bed according to claim 5, wherein when the four-bar linkage structure rises to the second position, an included angle between the overturn lever and a horizontal surface does not exceed 90 degrees.

10. The bed according to claim 6, wherein the four-bar linkage structure is a crank-rocker.
